(19) United States
(12) Patent Application Publication
(10) Pub. No.: US 2024/0388090 A1
(43) Pub. Date: Nov. 21, 2024

(54) LOAD MANAGEMENT AND PROTECTION SYSTEM FOR THE ELECTRICAL INFRASTRUCTURE OF A BUILDING

(71) Applicant: Jean-Philippe Therien, Mirabel (CA)

(72) Inventor: Jean-Philippe Therien, Mirabel (CA)

(21) Appl. No.: 18/632,687

(22) Filed: Apr. 11, 2024

Related U.S. Application Data
(60) Provisional application No. 63/503,273, filed on May 19, 2023.

(30) Foreign Application Priority Data
Mar. 22, 2024 (CA) 3232953

(51) Int. Cl. H02J 3/14; H02J 13/00

(52) U.S. Cl. CPC H02J 3/144; H02J 13/00004; H02J 2310/12

(57) ABSTRACT

A system for managing loads and protecting the electrical infrastructure of a building comprising of several units, configured to generate control signals when the current or power consumed on the main feeder of the building, on the secondary feeders, or on the main feeders of units exceeds the protection thresholds configured for each of these connections.

### CROSS-REFERENCE TO RELATED APPLICATIONS

This application claims priority to Canadian Patent Application No. 3,232,953 filed Mar. 22, 2024, which claims priority to U.S. Provisional Application No. 63/503,273 filed May 19, 2023, the entire disclosures of which are incorporated herein by reference.

### TECHNICAL AREA

The technical field of the invention relates to equipment, systems and methods for monitoring, managing and offloading energy consumption in buildings, in particular for protecting the electrical infrastructure of all types of building, including multiple dwellings with electric vehicle charging stations.

### BACKGROUND

As the use of electric vehicles increases, so does the need to integrate charging stations and power consumption control equipment into living spaces. In multi-unit buildings, such as condominiums, charging stations and related equipment can be installed during building construction or, more frequently, added to existing building electrical systems. Charging equipment typically includes an electrical interface for adding a branch from the main feeder to a dwelling or unit, the branch being used to connect to a charging station. Energy consumption for recharging the battery of an electric vehicle can then be billed to the owner of the proper unit.

However, charge controllers associated with the charging stations are configured to monitor only the unit's main feeder and the branch for the charging station. As charging stations are added to buildings to meet the needs of electric vehicle owners, energy demand increases on the building's main feeder. Electrical systems in new or existing multi-unit buildings are not designed for a situation where several unit owners may want to add a charging station for their electric car. As a result, electrical infrastructure in buildings, including multi-dwelling units, are likely to meet or exceed their design specifications as the number of electric vehicle owners increases. There is therefore a need for an improved system and a method to mitigate this risk.

### SUMMARY

According to one aspect, a system for monitoring and managing the energy consumption of a main feeder of a building is proposed. The building may be any type, including, in particular, multi-unit buildings, where a unit may correspond to a dwelling, a dock or a commercial office. The system may comprise at least one power monitoring device adapted to monitor and/or measure the total energy consumption on the main feeder of the building, the main feeder of the building being connected to a mains or main power line from an electricity supplier at one end and to feeders, including transformer subfeeders and/or unit main feeders, at another end. The system may comprise a control unit adapted to control the power and/or current consumed on load branches or lines. The branches are derived from main feeders of units and supply added loads, such as charging stations, at another end. The control unit may comprise a controller adapted to control the load shedding of the branches or added loads, if they are configured to receive load shedding signals directly, according to the measurement of the total energy consumption on the main building feeder, on the secondary feeders and/or on the unit feeders, so that the maximum energy consumption threshold for the infrastructure, at these different levels, is never exceeded.

According to one possible embodiment, the system may comprise an interface module for displaying measurements and other monitoring data. The interface module may comprise input ports and peripherals, such as a touch screen, keyboard or software application, allowing a user to interact with the interface module.

In one possible embodiment, the system includes may include means for communicating with and controlling charging stations, via third-party charging station controllers. In other embodiments, the system may comprise interception boxes, connected to the control unit and to the controller. The interception boxes intercept the main feeders (connections or electrical lines) of the units from which the branches are connected. The interception boxes include means for off-loading the branches associated with the added loads (such as charging stations). The controller of the control unit can be configured to determine the residual power per feeder, defined as a difference between the maximum energy consumption threshold and the total energy consumption, and to control the added loads, between different states, including for example a connected, unloaded or disconnected state.

According to another aspect, a system for monitoring and managing the power consumption of a main feeder of a multi-unit building is proposed. The system comprises at least one power monitoring device adapted to monitor and/or measure the total power consumption on the building's main feeder. This main feeder feeds secondary feeders (or secondary lines) and/or a building common service feeder (or common service line), and unit main feeders (or unit lines). The system can receive, via a control unit, signals indicative of status or indicative of current or power measurements. The control unit is able to generate signals to control the connection, load shedding and/or disconnection of branches, derived from the aforementioned feeders, according to the states and/or measurements received, so that at least one consumption threshold is never exceeded. In preferred embodiments, the system enables different thresholds to be considered, associated with the feeders according to their hierarchy in the building's electrical infrastructure.

According to another aspect, a method for monitoring and managing energy consumption on an electrical infrastructure of a multi-unit building is proposed. The method comprises the following steps: detecting, in real time, power consumption on the building's main feeder; on secondary or common service feeders, where present; and on each of the building's main unit feeders. The units in question are associated with branches supplying additional loads, such as charging stations for electric vehicle recharging. The method involves determining, on the basis of the measurements or states received, and on the basis of the power or current available or possible on each feeder, the residual power (or current), to control the charging stations or branches, so as to ensure that thresholds set for the different types of feeders in the building infrastructure are not exceeded.

According to one aspect, a system for load management and electrical infrastructure protection of a building is proposed. The building may comprise several units, or a unit may, in one possible embodiment, correspond to a dwelling. The electrical infrastructure of the building may comprise a main building feeder, secondary feeders derived from the main building feeder, and main unit feeders. Secondary feeders may be connected to transformers associated with a metering center. The main building feeders can be connected to the metering center, and more specifically to the meters of the metering center. A building's main feeder is supplied by an electricity distributor, and a protection device protects the building's main feeder. The building's electrical infrastructure also includes branches associated with some of the main unit feeders. These branches can supply additional loads, such as charging stations.

The protection system can include an input/output module for receiving signal(s) indicative of the current or power consumed on the building's main feeder, the current or power consumed on secondary feeders, and/or the current or power consumed on main unit feeders. The signal(s) may also be indicative of the current or power consumed on the branches, or of the connection status of the branches. The input/output (1/O) module can transmit load-shedding or reconnection control signals, enabling load-shedding or reconnection of at least one of the branches. The system also includes an interface module capable of setting different thresholds associated with the feeders, including for example a first load-shedding (or protection) threshold associated with the main feeder, a second load-shedding (or protection) threshold associated with the secondary feeders (or secondary lines/conductors) and a third load-shedding (or protection) threshold associated with the main unit feeders. The system can also include a controller connected to the input/output module and to the interface module, configured to generate control signals when the current or power consumed on at least one of: the main building feeder, the secondary feeders, and the main unit feeders exceeds the thresholds associated with these feeders, i.e. one of the first, second or third load-shedding thresholds. The control signals can be control and/or modulation signals for branch circuit opening mechanisms, or for electrical components located either in electrical charging station controllers, or in the electrical charging stations directly.

According to possible embodiments, the first, second and third load-shedding thresholds represent the limits, in amperes, above which load-shedding control signals are generated to cut off power to the branches or added loads.

According to possible embodiments, the system, for example via the interface module, allows to set a first safety threshold associated with the main building feeder, a second safety threshold associated with the secondary feeders and a third safety threshold associated with the main unit feeders. The first, second and third safety thresholds represent the limits, in amperes, below which reconnection control signals are generated to reconnect shed branches. It is understood that each feeder, connection or branch may also be associated with its own threshold. For example, secondary feeders could have separate thresholds associated therewith. The same applies to each unit's main feeder.

According to possible embodiments, the system, for example via the interface module, allows or is able to parameterize a time or duration for branch load shedding before the controller can generate reconnection control signals.

According to possible embodiments, the system, for example via the interface module, enables or is able to set a stabilization time during which the power consumed on one of the: main building feeder; secondary feeders or lines; and unit feeders must remain below their respective safety thresholds before the controller sends reconnection control signals.

According to possible embodiments, the system, for example via the interface module, enables or is able to set a reconnection delay before the controller can generate a reconnection control signal following the sending of a load-shedding signal.

According to possible embodiments, the system, for example via the interface module, enables or is able to set a charging time reset delay associated with the branches. The charging time reset delay can be saved by the controller to prioritize some of the branches.

According to possible embodiments, the system, for example via the interface module, enables or is able to set an overload delay after which an overload on one of the: main feeder of the building; secondary feeders; and main feeders of the unit will be taken into account by the controller.

According to possible embodiments, the system can be designed and configured for a building comprising several secondary feeders or secondary lines, one of which is used or dedicated to supplying common electrical services. The system, for example via the interface module, can be used to configure activation periods for devices supplied by the secondary feeder dedicated to common services. The controller can generate load-shedding and reconnection control signals for devices such as fans, heating modules and emergency lighting, according to the configured activation periods.

According to possible embodiments, the system, for example the interface module, comprises a display panel or window displaying in real time the current or power consumed on the main feeder of the building; on the secondary feeders and/or on the main feeders of the units.

According to possible embodiments, the interface module may comprise a panel or display window showing the connection status of the leads in real time.

According to possible embodiments, the connection status displayed is indicative of charging, load shedding or non-connection of charging stations associated with the branches.

According to possible embodiments, the signals indicative of the current or power consumed on the feeders (or electrical line/connections) or indicative of the connection status of the branches come from transducers installed on the main building feeder; on the secondary feeders, and on the main unit feeders.

According to possible embodiments, the transducers associated with the main building feeder may be located in the building protection device. Transducers associated with secondary feeders may be located in power transformers of the electrical infrastructure. Transducers for the main unit feeders can be located in charging station controllers or in main unit feeder interception boxes.

According to possible embodiments, the system, for example via the interface module, may include a scaling or calibrating panel or window for calibrating measurements from the transducers, depending on the transducer model used.

According to possible embodiments, the system may further comprise controllers for electric vehicle charging stations and/or interception boxes for the main feeders of the units. Each charging station controller or interception box can be connected to one of the branches and to the electrical panel of the unit associated with a charging station powered by the branch.

According to possible embodiments, signals indicative of the current or power consumed on each unit main feeder of the unit (or main connection of the unit) are received from electric vehicle charging station controllers external to the protection system.

In possible embodiments, control signals transmitted by the system controller and/or signals indicative of current, power or connection status received from the system controller are relayed by wired communications.

According to possible embodiments, communications can be carried out according to a standard protocol, for example one of the following protocols: Open Charge Point Protocol (OCPP), IEC 63110 or ISO15118, without limitation.

According to possible embodiments, the controller is configured to transmit load shedding control signals to the charging station controllers, to the interception boxes associated with the respective branches or to the charging stations directly, when the power consumed on the building's main feeder or on one of the secondary feeders exceeds their associated load shedding thresholds.

According to possible embodiments, the control signals enable the load shedding or reconnection of one or more of the branches by activating a circuit opening mechanism in one of the charging station controllers or in one of the interception boxes. The opening mechanism can be of various types, including but not limited to a contactor, relay or circuit breaker.

According to possible embodiments, the system may also include a software application and/or a controller interface that is remotely controllable, enabling access to the controller to obtain current or power values of the building's feeders (main connection and/or secondary connections) and/or the connection status of the branches.

According to possible embodiments, the first, second and third load-shedding/protection thresholds and the first, second and third safety thresholds can be configured by an authorized user of the protection system, for example via the interface module.

According to another aspect, a system for protecting the electrical infrastructure of a building comprising several units is presented. In this case, the electrical infrastructure may comprise only a main building connection/main feeder of the building powered by an electricity distributor and protected by a protection box, a metering center, feeders associated to each unit, connected to the metering center, and branches associated with some of the feeders of the units for supplying charging stations. Thus, in some embodiments, the infrastructure may not include transformers or secondary feeders/connections. The protection system may then comprise an input/output module for receiving signals indicative of: the current or power consumed on the building's main feeder; the current or power consumed on the unit feeders; and a branch connection status. The I/O module can also transmit load-shedding or reconnection control signals, enabling load-shedding or reconnection of at least one of the branches or charging stations. The system can include an interface module for setting a first load-shedding threshold associated with the building's main feeder and a second load-shedding threshold associated with the unit feeders. The system may also include a controller connected to the input/output module and the interface module, configured to generate control signals when the current or power consumed on the building's main feeder or on one of the unit feeders exceeds one of the load-shedding thresholds.

The first and second load-shedding thresholds can represent the limits, in amperes, above which control signals are generated to load-shed or modulate the branches or charging stations. All the features described in the preceding paragraphs in connection with the first aspect of the invention can be applied to this aspect as well.

According to another aspect, a method for managing loads and protecting a building's electrical infrastructure is proposed. The method may comprise receiving or accessing signals indicative of current or power consumed on the building's main feeder; current or power consumed on secondary feeders, current or power consumed on main feeders of units; and current or power consumed on branches and/or at least one branch connection state. The method can also include the generation or transmission of control signals, such as modulation, load shedding or reconnection signals, to control, for example by load shedding or reconnection, of the branches. The method can also enable different protection thresholds associated with the feeders of the electrical infrastructure to be set or configured, including, for example, a first load-shedding or protection threshold associated with the building's main feeder, a second load-shedding threshold associated with the secondary feeders or connections and a third load-shedding threshold associated with the feeders of the units. The method can also include generating or transmitting control signals when the current or power consumed on at least one of: the building's main feeder, the secondary feeders, and the unit feeders exceeds one of the thresholds set for these feeders, for example, one of the first, second or third load-shedding thresholds.

### BRIEF DESCRIPTION OF FIGURES

FIG. 1 shows a block diagram of an electrical infrastructure protection system for a multi-unit building, according to one possible embodiment.

FIG. 2 shows a block diagram of an electrical infrastructure protection system for a multi-unit building, according to another possible embodiment.

FIG. 3 shows a block diagram of a component of the multi-unit building electrical infrastructure protection system, according to one possible embodiment.

FIG. 4 shows a flow diagram illustrating possible steps in a method for protecting the electrical infrastructure of a multi-unit building, according to one embodiment.

FIG. 5 shows a display panel of a protection system interface module, displaying in real time the status of the building's main feeder and secondary feeders connected to transformers, according to one possible embodiment.

FIG. 6 shows a display panel of a protection system interface module, enabling building units to be associated with their respective door numbers, according to one possible embodiment.

FIG. 7 shows a display panel of a protection system interface module, enabling protection thresholds associated with the building's main feeder, secondary feeders and unit feeders to be set, according to one possible embodiment.

FIG. 8 shows a display panel for a protection system interface module, to calibrate transducers used to generate measurements indicative of the current or power consumed on the building's main feeder, secondary feeders or unit feeders.

FIG. 9 shows a display panel of a protection system interface module, enabling system actions and controls to be set, in particular with regard to load shedding periods and reconnection delays, according to one possible embodiment.

FIG. 10 shows a display panel of an interface module for configuring activation periods of devices supplied via a secondary feeder connected to a transformer for common services, according to one possible embodiment.

### DETAILED DESCRIPTION

For simplicity and clarity of illustration, where deemed appropriate, reference numbers may be repeated or omitted in the figures for corresponding or similar elements or steps. In addition, many specific details are explained to enable a thorough understanding of the exemplary embodiments or modes of realization described herein. However, those of ordinary skill in the art will understand that the embodiments described herein can be implemented differently or with equivalent components or steps. Furthermore, this description should not be taken as limiting in any way the scope of the embodiments described herein, but rather as describing possible embodiments or configurations.

One or more of the systems described herein may be implemented at least in part by computer programs running on controllers or processing devices, including for example a programmable logic controller (PLC) or PLCs, comprising at least one processor, a data storage medium (including volatile and non-volatile memories), communications module(s), and at least one input and/or output module. A processing device may include computers, servers, PLCs and/or specialized electronic devices that receive, process and/or transmit data. Processing devices” are generally part of “systems” and comprise processing means, such as microcontrollers and/or microprocessors, such as CPUs, or are implemented on FPGAs, by way of example only. For example, and without limitation, a processing device may comprise a programmable logic unit, a mainframe computer, a server, a PLC, a personal computer or laptop, a cloud-based program or system, a personal data assistant, a cell phone, a smartphone, a wearable device or a tablet. In an industrial and/or electrical circuit control context, processing devices are preferably specialized and highly reliable, such as programmable logic controllers.

Each program is preferably implemented in a high-level procedural or object-oriented programming and/or scripting language, such as Ladder Language (LD), Sequential Event Language (SFC), Contact Schema Language (FBS), Python, C++, JavaScript or other equivalent language. Programs can also be implemented in assembly language or machine language, depending on the application. The language can be a compiled language, interpreted or not. Each of these computer programs is preferably stored on a storage medium or processor-readable device to execute the procedures described herein.

The processor(s) is (are) used in combination with a storage medium, also known as “memory” or “storage medium”. The storage medium can contain instructions, algorithms, rules and/or business data to be processed. The storage medium includes volatile or non-volatile/persistent memories, such as registers, caches, RAMs, flash memories, ROMs, diskettes, compact disks, tapes, chips, by way of example only. The type of memory is of course chosen according to the desired use, whether it is to store instructions or to temporarily store, retain or update data. The steps of the proposed method are implemented in the form of software instructions and algorithms, for example stored in the memory of a PLC, and executed by processors.

In the present description, the term “electrical load” or “load” refers to a load connected to an electrical connection and is associated with the electrical power consumed (or current/amperage consumed) by the electrical components forming the load. The power consumed in an electrical circuit can be related to the instantaneous current through the circuit resistance, and this relationship can vary according to the specific characteristics of the load and the circuit (through phase and reactance effects). For example, the electrical load of a building's main feeder can be related to the electrical power consumed by the electrical systems and devices of all the units (e.g. housing, parking spaces and/or offices) in the building. Similarly, the electrical load of a feeder can be associated with the load of all the electrical systems and devices connected, directly or indirectly, to this feeder, and the electrical load of a unit can be associated with the load of all the electrical systems and devices connected to the unit's main electrical feeder (or connection), and with the energy consumed by this load. The main feeder in a building's electrical infrastructure (installation or network) is an electrical power supply line designed to carry the building's total electrical load, and is generally sized according to the electrical capacity required by all the equipment and appliances connected to the building's electrical network. It is often protected by an overload protection device, to ensure the safety of the electrical system and building occupants in the event of an electrical overload or short-circuit. A “secondary feeder” refers to an electrical connection that distribute electricity from the main feeder to specific areas or blocks within the building. A secondary feeder may be connected to a transformer or to a metering center. In some embodiments, a transformer or transformers are required to lower the voltage in blocks of units. A metering center, including electricity meters, is usually connected to the transformer. Secondary feeders and unit feeders can be made up of electrical cables of different dimensions (or gauge), depending on the design of the building's electrical system. A branch typically branches off from an electrical feeder and is connected to a load. In the context of electrical installations in buildings, a branch can be understood as an auxiliary connection, extension or branch of a main feeder or connection, often used to supply specific electrical components, such as charging stations.

When planning or adding electrical loads to an electrical installation (referred to as “added loads”), load calculations must first be carried out to ensure that the size of the various cables, circuits and connections is adequate and safe. These calculations must take into account different types of loads, including basic loads (e.g. lighting loads and electrical outlets), heating loads and other similar loads (electric heating, water heater, electric stove, clothes dryer, charging stations), as well as common loads (hallway and garage heating, garage ventilation, alarm and fire systems, etc.). Although adjustments have been made to load calculation regulations to take account of the addition of charging stations, the calculation methods used are based on past consumption statistics, which may not be representative of future electricity consumption, which is difficult to predict given the rapid development of the various electric appliances and vehicles available on the market, and their charging methods. Furthermore, when adding loads associated with building units, there is a risk that upstream load calculations will not be updated, jeopardizing the building's electrical infrastructure, particularly in the event of broken or malfunctioning safety circuit breakers.

Generally speaking, the present description relates to a system for protecting the electrical infrastructure of a building, such as a multi-unit building, by managing the loads supplied by the building's infrastructure. Although the present system is particularly well suited to the protection of electrical infrastructure of multi-unit buildings, the proposed system can be adapted and used for other applications, such as commercial parking lots, dock installations with electric boats, given as examples only, and without limitation. The proposed protection system is particularly suitable for protecting building electrical infrastructures when adding loads (added loads) to be powered by an electrical infrastructure.

In some embodiments, the system may notably monitor and manage the electrical infrastructure of a multi-unit building in order to avoid reaching or exceeding the maximum load, or maximum energy consumption, allowed by the building's electrical systems and/or by the electricity supplier. According to one possible embodiment, these maximum limits can be monitored or managed by configuring or parameterizing them in the proposed system. A building's electrical infrastructure may contain a main feeder, fed by a mains or mains line provided by an electricity distributor. The building's electrical infrastructure may also include a main protection box (comprising, for example, a circuit breaker or switch) protecting the building's main feeder. The building's electrical infrastructure may also include one or more secondary feeders or connections, which may be connected directly to one or more metering centers, or may be connected to power transformers (depending on the voltage/size of the building). The building's electrical infrastructure may also include unit feeders, associated with dwellings for example. Some of the unit feeders may feed branches (some of which may be referred to as charging connections, or auxiliary connections connected to charging stations. Branches may power other types of added loads. By “some” of the unit feeders, we mean that a subset of the unit feeders may have branches for charging batteries of electrical vehicles. This means that some of the main feeders of units may have branches, while others may not. Depending on the number of units in the building, there may be no secondary feeder associated with a power transformer, with the main feeder(s) of units being connected to a metering center(s). Depending on other building configurations, such as buildings with a high number of units, many secondary feeders may be connected to power transformers, for example associated with blocks or complexes of dwellings.

The building can therefore include a number of branches (also known as “charging lines” or “auxiliary supply lines”) for charging electric vehicles or other types of loads, each of which can be associated with the vehicle owner's electricity meter and/or panel. According to one possible configuration, the branches can be connected to a charge controller, then to an electric meter at one end, and a charging station at another end. The system described here is particularly well suited to managing and controlling each of the branches according to the consumption measured upstream of these branches, including the building's secondary feeder and the building's main feeder, which advantageously makes it possible to charge as many electric vehicles safely for the entire electrical infrastructure of a building, without exceeding the electrical infrastructure's maximum capacity.

In one possible embodiment, the system can be configured to determine either the total power consumed (or current), or the residual power, or residual load, of the building by monitoring the power consumed on the building's main feeder, on the secondary feeder(s), on the main feeders of the units and/or on the branches. This determination can be carried out, for example, using current transducers (commonly called “current transformers” or “CTs”), by comparing measurements derived from signals received by the transducers with various thresholds set in the system controller. As a result of this determination, the system can be configured to determine whether branches need to be connected or disconnected, in order to meet specified consumption thresholds. The system can also be configured and adapted to sequentially alternate the connection and disconnection of branches powering charging stations, so that when residual power is limited, available power can be sequentially distributed between the different charging branches or charging stations. In other words, the system is capable of sharing available residual power over time between branches, so that recharging of electric vehicle batteries can be carried out one after the other, for a given set of charging stations. For example, the system can be configured to allocate a charging period (e.g. 90 min) for each connected charging station, with the system controlling the connection and disconnection of the branches according to this charging period. Depending on the charging station connection sequence, determined by the connection status of the charging stations, the priority or order in which recharges take place can be controlled by the system.

Advantageously, the system makes it possible to monitor the building's total energy consumption and manage the load of several electric vehicles connected to the branches, while preventing maximum energy consumption thresholds from being exceeded on the building's main electrical feeder, on the building's secondary feeders and/or on the units' feeders (or unit connections), by offloading one or more branches when necessary. The proposed system therefore makes it possible to protect the building's electrical infrastructure, not just the feeders of the units.

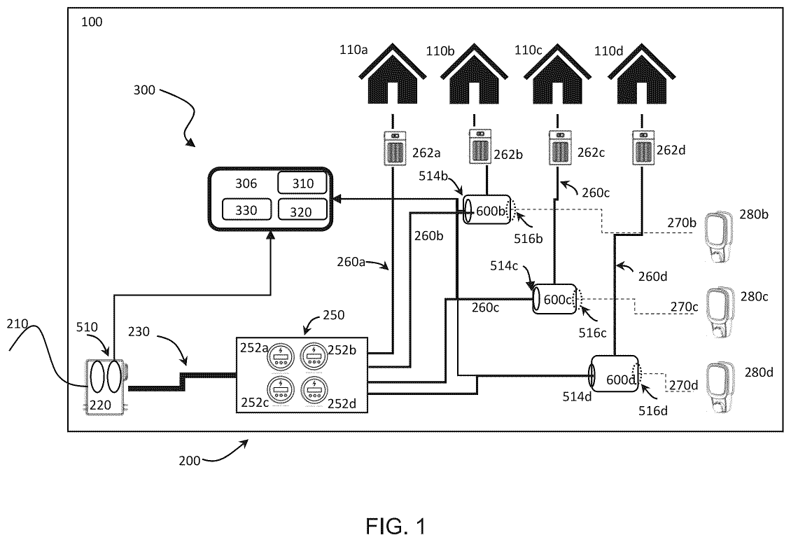

Referring now to FIG. 1, electrical infrastructure protection system 300 is installed in a building 100 comprising several units 110a-110d or dwellings. For buildings other than multi-unit buildings, such as condos, a unit may correspond to a camping space, a parking space or an electric boat dock. These types of buildings or facilities are examples only, and the present system can be used with, but is not limited to, other types of buildings or facilities.

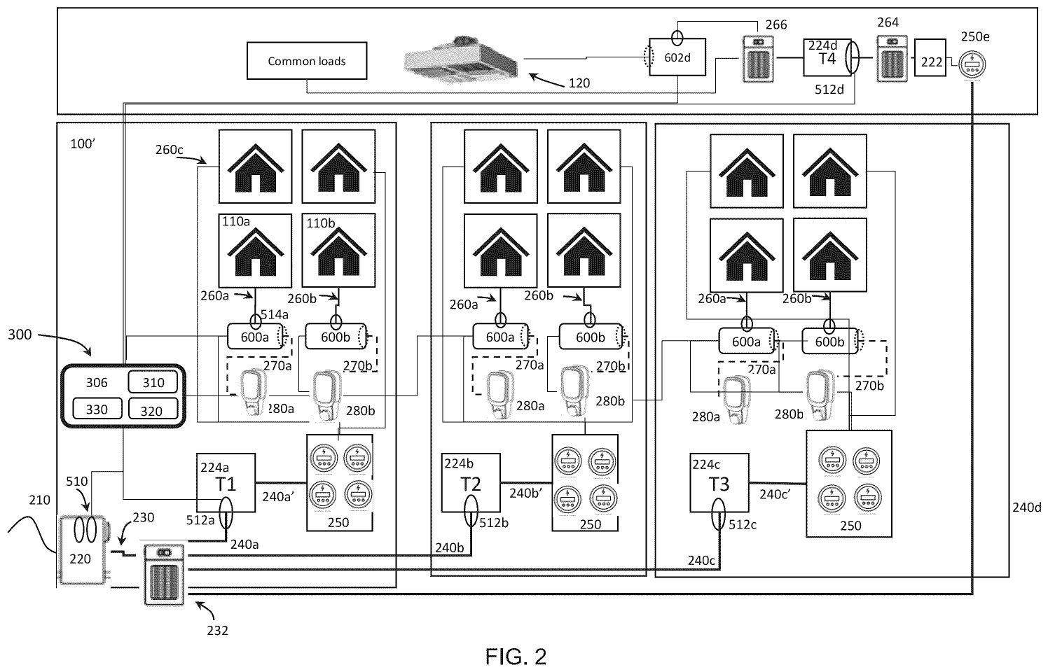

Electrical infrastructure 200, also referred to as “electrical installation”, refers to the conductors, wiring and electrical equipment (connectors, cables, circuit breakers or disconnectors, panels, transformers, meters, etc.) for transmitting energy and powering appliances requiring current to operate. The building's electrical infrastructure may include: the mains or mains line 210 powered by an electrical distributor; a protective device 220 (circuit breaker, disconnect switch or main switch) protecting the building's main feeder 230, a main electrical panel 232 (identified in FIG. 2, and not always required, depending on the number of units to be powered/served); none, one or more secondary feeders (240a-240c, shown in FIG. 2), connected to or branching off the building's main feeder 230, one or more transformers (also shown in FIG. 2, 224a-224b) located between the secondary transformer feeders (240a, 240b, 240c) and the main feeders of units 260a-260c associated with each unit 110a-110b, branch lines 270b, 270c, 270d associated with some of the units 110b-110d.

Still referring to FIG. 1, a protection device 220, connected to the building's main feeder 230 and to the mains 210 from the power distributor, may be configured to cut off power to the building's main feeder in the event of a power surge. The example building 100 comprises a number of units 110, each associated with an electricity meter 252 of a metering center 250 comprising several electricity meters. An electric meter (or other suitable metering device) measures the energy consumption of each unit 110a-110d, in power (kW or kWh). The measurement can also be a current measurement, when the voltage is known or measured. Electricity is supplied to each unit 110a-110d via the main feeders of the units 260a-260d (or unit connections), operatively connected to a meter at one end, and to a unit electrical panel 262a-262d at another end. For each unit 110b-110d associated with a charging station, or charging apparatus, or other suitable charging system for electric vehicles, the unit main feeder 260b-260d is operatively connected to a charging station controller 600b-600d, which couples the unit main feeder 260b-260d to a branch 270b-270d for powering the charging station. Operationally linked or connected means that the components can be connected or linked directly, without intermediate components, or indirectly, with intermediate components, such as junction means. It is also understood that the connections shown in FIG. 1 are one of several possible configurations, and the system can protect the electrical infrastructure of buildings with a different connection configuration from that shown.

Still referring to FIG. 1, according to one possible embodiment, the protection system 300 comprises an input/output module 320 for receiving signals (or measurements) indicative of the current or power consumed on the building's main feeder and of the current or power consumed on the unit feeders 260b-260d. If the electrical infrastructure includes secondary feeders or connections, the input/output module 320 also receives signals indicative of the current or power consumed on the secondary feeders. The input/output module 320 can also receive the connection status of the charging stations (such as connected, disconnected, not connected). The connection status can be derived from measuring the current or power consumed by the charging stations, via transducers 516b-156c-516d associated with the branches. For example, a current above 5A on the branch indicates a charging station that is connected and recharging, a low current (e.g. smaller than 5A) indicates a charging station that is connected but offloaded, and no current detected indicates an a charging station and this unconnected. The input/output module 320 can also transmit control signals, including load-shedding or reconnection signals, enabling load-shedding or reconnection of at least one of the branches 270b, 270c, 270d. Load shedding or reconnection can be performed by control signals which activate or deactivate a circuit opening mechanism, such as a contactor in a load controller 600 or in an interception box 602. Various types of electrical circuit opening mechanism can be considered, such as, but not limited to, contactors, circuit breakers and relays. The connections between the various transducers, charging station controllers (or interception box) are not all shown in the figures, but it is understood that the control unit 306 of the system 300 receives and transmits all the signals (measurement, status or control) required to implement the method for protecting the building's electrical infrastructure. For greater security, communications between the controller of charging stations, interception boxes and/or transducers and the control unit 306 are preferably wired.

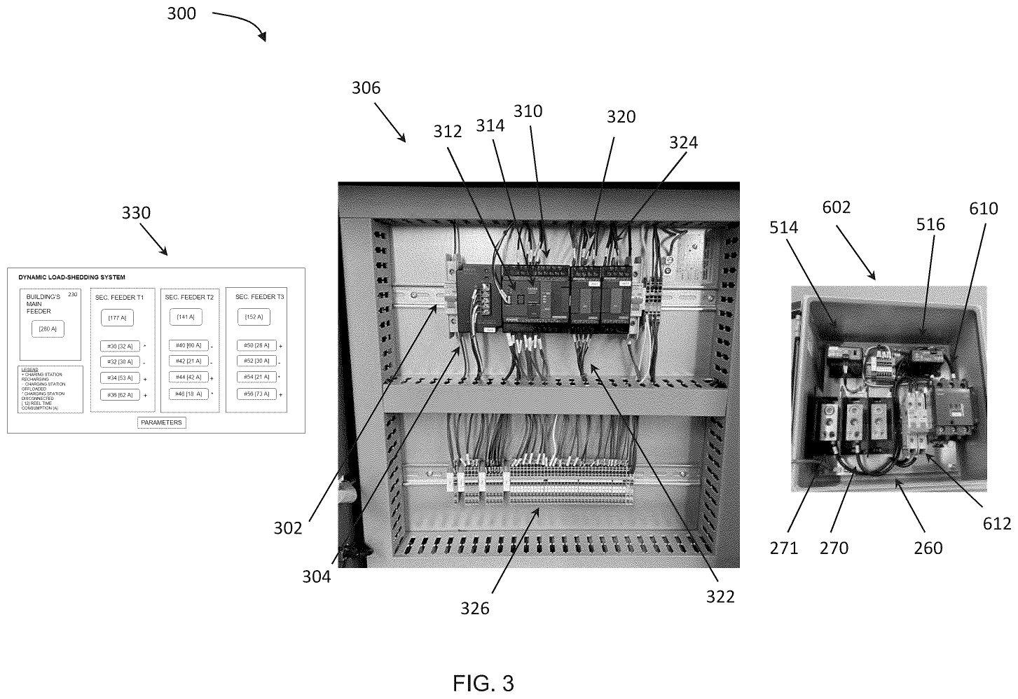

The system 300 may also include an interface module 330 allowing to set or configure various parameters, including, for example, different protection or load-shedding thresholds associated with the various feeders or connections of the electrical infrastructure 200. For example, the 330 interface module can be used to set a first load-shedding threshold associated with the building's main feeder 230, a second load-shedding threshold associated with the secondary feeders and a third load-shedding threshold associated with the main unit feeders. It may be possible to set only one threshold for the building's main feeder and/or secondary feeders, depending on requirements and whether the system is to operate in combination with an existing monitoring or management device. System 300 may also include a controller 310 connected to input/output module 320 and interface module 330. The controller 310 can be configured or programmed to generate control signals when the power consumed on at least one of: the building's main feeder, the secondary feeder(s) associated with the power transformers, if present, and the units main feeders exceeds one of the load shedding thresholds. The controller 310, the input/output modules 320 and the interface module 330 may form part of a single control unit 306, or may be divided between several separate, but interconnected, components. The controller may therefore comprise one or more modules or units, for example several PLC modules, as shown in FIG. 3. In this way, it is understood that the functions of the various modules can be divided, combined or otherwise distributed within the control unit. The grouping of I/O module, controller and interface module functions may therefore be different from that shown here. The control unit itself may also be configured differently, and split into sections or sub-units different from those shown here. Certain functions can be performed outside the control unit, and distributed, for example, in the load controllers or interception boxes described below.

The 300 system can therefore be configured and programmed to monitor at least the building's main feeder, but also preferably the other feeders or connections/electrical lines of the infrastructure, and to control the use of the 270b-270d branches, for example by controlling the 600b-600d charge controllers, by sending control signals for load shedding or reconnection of the corresponding 270b-270d branches. Advantageously, the system 300 can authorize the distribution of current to recharge the batteries of electric vehicles when the total current consumption (or consequently power consumption) of the electrical appliances in the building 100 is within a given power range, or below a given threshold, and prevent charging of the electric vehicles when the total load exceeds or reaches a given threshold. In this way, the present system can take into account not only the current consumption of each unit, but also the total consumption on the secondary transformer feeders (where present) and ultimately on the building's main feeder.

In one possible embodiment, the system 300, for example via the input/output module, may receive a signal or measurement indicative of the current or power consumed on the building's main feeder. This signal or measurement may come from a main load monitoring device 510 adapted to monitor and/or measure, in real time, the current or power (or other equivalent parameter) flowing through the building's main feeder 230, and thus through the building's entire electrical infrastructure. In some embodiments, the main load monitoring device 510 is an alternating current (a/c) sensor or transducer adapted to detect current through the main line 230. For example, a current transducer (CT) may be magnetically coupled to the building's main feeder 230 to detect alternating current on the main line 230. The main load monitoring device 510 may be external to the system, and the system may simply receive signals from the device 510, or the system may comprise the device and be an integral part of the system. The main load monitoring device may be located in the protection device 220, and connected (preferably by wire) to the control unit 306. As the voltage supplied by the utility becomes known, the energy consumption (power) by the building's main feeder 230 can be calculated or determined. Note that other current or power detection or measurement devices may be used, such as current transformers, amperemeters or any other device suitable for detecting the current, voltage and/or power consumption of the building's main feeder 230. The transmission of signals or measurements indicative of the current or power consumed on the main feeder can be wired and relayed via a terminal block connected to the input/output module 320, or wireless, according to possible modes of realization.

In some embodiments, the system 300 also comprises of at least one unit load monitoring device 514a-514d, adapted to monitor and/or measure power consumption on the main feeders 260a-260d of units. For example, a secondary load monitoring device 514b-514d may be installed in a load controller 600b-600d to read the current consumption of each unit feeder 262b-262d. A secondary load monitoring device may be a current transducer or any other device suitable for monitoring current, voltage and/or power consumption by the main unit feeder 260b-260d. The 514b-514d monitoring device can be used to monitor the power consumption of a given unit or dwelling, including or excluding the power consumption of the charging station. It can be advantageous to monitor the power consumption of each unit in real time, as energy resources can be shared between units 110a-110d according to their respective power consumption. Note that measurements of current consumption or power consumed on each unit feeder can be obtained either from electric vehicle charge controllers 600b-600d, which may be external to the system 300 or included in the system 300, or from current transducers independent of electric vehicle charge controllers. These transducers may also be included in an intercepting box 602 provided with contactors (shown in FIG. 3). An interception box allows a unit's main feeder to be intercepted and to derive therefrom a branch towards a charging station; to determine the state of the branch or charging station (whether charging, shedding, unconnected), and to control (via an on/off contactor, for example) the connection or shedding of the branch, according to control signals received by a control unit 306, described below.

In addition, the system 300 may also include load monitoring devices adapted to measure the current or power consumption of branches 270b-270d, and thus the energy consumed by the charging stations 280b-280c. Note, however, that the monitoring devices of units 514b-514d and the branch monitoring devices may not be necessary in some embodiments. This is especially the case when these measurements or signals can be sent or generated by the charging station controllers 600b-600d and/or by the charging stations themselves 280b-280d. In some embodiments, it is not necessary for the control unit to know the current or power consumed by a given charging station, but simply its status, i.e. whether the station is charging, unloaded or unconnected.

FIG. 2 shows a building with an electrical infrastructure different from that shown in FIG. 1. In this embodiment, the building comprises more than one multi-dwelling unit. In this case, the building's main feeder 230, protected by protection device 220 (circuit breaker or switch), is connected to a main panel 232 in which there are circuit breakers connecting secondary feeders/connections 240a, 240b, 240c associated with power transformers 224a, 224b, 224c. Each of the secondary feeders 240a-240c (corresponding, for example, to phases A-B, phase A-C and phase B-C of the three-phase main feeder), is connected to the respective transformers T1, T2, T3 (224a-224c). For each of the secondary feeders, load monitoring devices 512a-512c are installed to measure the current or power consumed on each secondary feeder 240a′-240c′. The load monitoring devices 512a-512c can be integrated into the transformers themselves, and operatively connected to the controller 310 of the system 300, for example via the input/output module 320 to receive the measurement signals independently. The current flow on each of the secondary feeders can be monitored and protected by the 300 system, by sending load shedding or reconnection control signals to the branches linked to one of these secondary feeders. The 300 system can therefore be used to protect the building's main feeder serving one or more buildings, and also to protect the secondary feeders branching off or connected to the main building feeder 230, the secondary feeders being linked to power transformers, depending on thresholds set in the system, as will be explained later in this application.

Still referring to FIG. 2, for a system 300 designed or adapted to protect an electrical infrastructure comprising several secondary feeders, one of which is used to supply common electrical services, the system 300 can take into account the energy consumption by these common services. Common services 120 (also referred to as “common loads”) may include ventilation or heating of a garage or parking spaces, heating or cooling of common corridors, lighting of common spaces, elevators, fire pump if present, emergency lighting system, etc. As described in more detail later, the system's controller 310 can take into account, in the management and control of the branches, the activation periods of devices powered by a secondary feeder or connection 240d dedicated in whole or in part to common services. The 310 controller can be configured to generate connection and reconnection control signals for common loads according to the configured activation periods. In one possible embodiment, the control unit can receive auxiliary contact signals from an alarm system or fire protection system. Depending on the status of these signals, for example, if an alarm condition is detected in connection with a possible fire risk, the controller can be configured to transmit control signals to disconnect the branches of the entire building, to reduce or mitigate risks in connection with battery recharging in an emergency situation.

Still referring to FIG. 2, the secondary feeder 240d for common loads can be connected to a meter 250e, then to a safety switch 222, a 3-phase main service panel 264 (PPS) (e.g. 347/600V), a 3-phase service transformer 224d, a secondary panel (PS) 266 (e.g. 120/208V). The secondary or main panel can supply different types of loads, depending on their power consumption. An interception box 602c with contactors can be connected to certain electrical equipment, e.g. parking fans 120, to control, via contactors (on/off), the operation of this equipment. Transducers can be integrated into the interception box to measure the current/power consumed by the various loads connected to the box and controllable via the control unit 306.

With reference to FIG. 3, according to one possible embodiment, the system 300 may comprise, in a control unit (or box) 306, a power supply 304, circuit breakers 302, input/output module(s) 320 capable of receiving measurements 322 indicative of the current or power consumed on the building's main feeder and/or the current or power consumed on the secondary feeders, if present, and/or the current or power consumed on the branches or a signal indicative of the state of the branches/charging stations (for example: charged, unloaded, not connected). An I/O module may include, for example, an analog extension module. By “measurements or signals indicative of” we mean any signal, analog or digital, wired or wireless, which includes status information or a current or power measurement itself, or data from which the current or power consumed on the given power supply line can be derived. The input/output module 320 is also able to transmit load-shedding or reconnection control signals 324 enabling load-shedding or reconnection of at least one of the branches and/or charging stations. In some embodiments, these control signals can be transmitted to a load controller 600 which comprises a load-shedding and reconnection device connected to one or more branches. In other embodiments, the control, measurement or status signals can be exchanged with an interception box provided with contactors and associated with a unit feeder, the contactors enabling a branch derived from the unit feeder to be connected or disconnected depending on whether the parameterized protection thresholds are exceeded. In some embodiments, the control signals can be transmitted directly to a charging station. In some cases, the charge controller may be integrated into the charging station(s) 280a-280d. The 306 control unit may be supplied in a housing and may include a terminal block or terminals 326 facilitating the connection of measurement and/or control signal wires. The input/output module 320 may comprise electrical and/or electronic components configured to condition the measurement signals received from the monitoring devices.

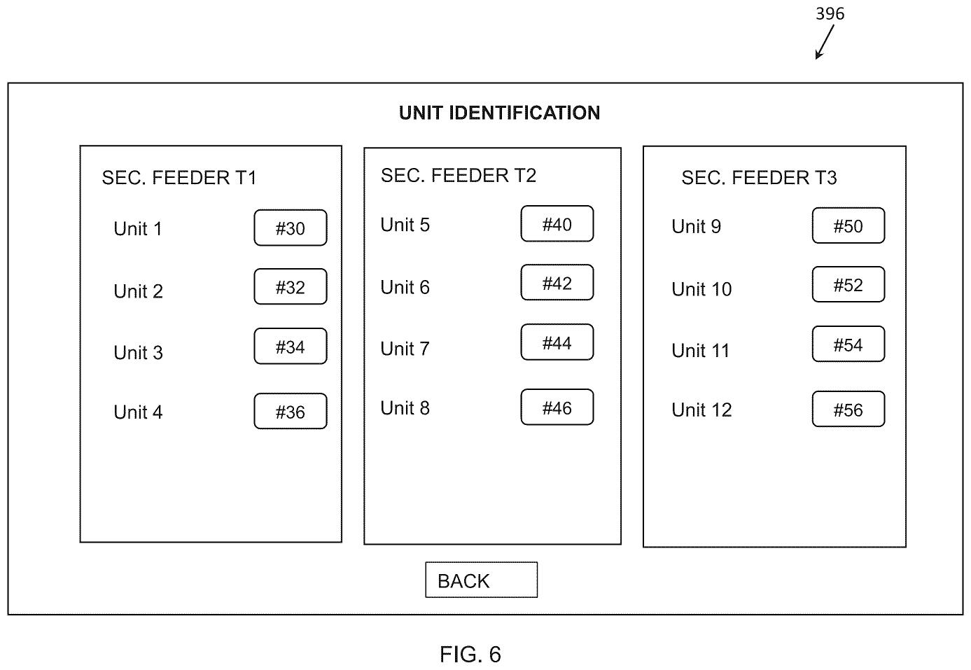

The system 300 may also comprise a controller 310 including one or more processors 312 and storage means 314 for storing instructions executable by the processor. The instructions, when read by the processor, enable the steps of the method described in more detail below to be executed. In one possible embodiment, the controller is a programmable logic controller (PLC) and the instructions are programmed in Ladder language, but other configurations are possible, such as an embedded computer equipped with a microcontroller or an FPGA. The controller 310 is connected to an interface module 330 and to the input/output module 320 and receives measurements or signals from the latter and is configured to process these signals in accordance with the method described below. The system 300 also includes a power supply unit, to supply power to the various modules of the control unit 306. The system's power supply may come from a 120V line derived from an electrical circuit supplied by one of the building's infrastructure electrical lines or connections. An external power source may also be used. The 306 control unit also includes a communication card or module for communicating with the remote controller, and for transmitting status/measurement information from the various feeders, so that it can be presented in an external, access-controlled application. The system can be configured with different levels of access, where first-level accesses allow modification of all parameters and/or control of load shedding of unit branches or charging stations, second-level accesses allow modification of certain less critical parameters (e.g. housing assignment as shown in FIG. 6), and third-level accesses allow consultation of read-only information and measurements, with no modification possible.

Still referring to FIG. 3, the system 300 further comprises an interface module 330 configured to provide information to system users, such as electricians or building managers, and to receive inputs for configuring certain parameters used by the controller 310 in its management and control of the building's electrical infrastructure feeders. The interface module 330 may comprise a digital display, such as a liquid crystal display (LCD), or light-emitting diodes (LEDs), for displaying information. The interface module 330 may also include push-buttons, buttons or any other control suitable for data input. The interface module 330 may also include a touch screen, which can both display information and receive data from an authorized user. The interface can be password-protected to prevent unauthorized personnel from modifying the parameters of the system 300. The interface module 330 can be used to monitor the power consumed by each unit 110a-110d and the current or power consumed (or other equivalent parameters) on the building's main feeder 230, secondary feeders 240a′-240, unit main feeders and/or branches. It is understood that any other appropriate information can also be displayed, such as average consumption on the various feeders/lines of the electrical infrastructure, the status of charge controllers, charging stations and/or branches, measurements read by current transducers, by way of example only. The interface module 330 can be integrated into the housing of the control module 306, for example by being integrated into the door providing access to the I/O module 320 and the controller 310. The interface module 330 can also be accessed via a dedicated software application, a web application or an app, enabling remote access to the controller 310 and/or to the various panels (or windows) for viewing or configuring the controller. For example, by communicating remotely with the controller, via a communication access, it is possible to control the branches of one or more buildings by completely or partially offloading them. It is also possible to control charging stations directly, when they can communicate via an intelligent protocol (e.g. OCPP), by modulating their charge. It is also possible to transmit the loads consumed for each unit, via wired or wireless communication, to a visualization pane or window in a software application. This pane or window can be displayed on a display screen located in a common part of the building (e.g. lobby), or via any other display screen with Internet or wifi access. This remote access can be used to monitor and adjust all 300 system parameters (protection thresholds, duration, delays, etc.). System 300 should preferably be protected by different security accesses, to control access to the system.

According to one possible embodiment, read access and/or power consumption information for a unit can be provided to users of the unit, so that they can view their power consumption in real time, for example via a monthly subscription to a web application. In another embodiment, the interface module can be in communication with a display panel or screen accessible in a common area of the building, enabling users to see the status of the building's charging stations (charging, load shedding or not connected) and whether there is any electrical capacity left to charge their electric vehicles.

As mentioned above, the interface module 320 can be used to configure certain operating parameters of the controller 310. For example, power thresholds, time constraints and energy consumption levels can be configured, automatically and/or manually, for each branch, as electric vehicles may have different charging capacities. In addition, as the 300 system enables the sharing of available residual power, charging duration, delays and timers can be configured using the interface module 330. In some cases, the interface module 330 can also be used to program and/or modify parameters such as charging parameters for each branch, charging cycles, load-shedding parameters, for example connecting and disconnecting branches in a predetermined sequence, as described below.

Still referring to FIG. 3, according to one possible embodiment, the system 300 may comprise one or more unit main feeder interception boxes 602 provided with contactors, which include a load-shedding device (contactor/breaker) 610 and electrical, electromechanical and/or electronic components configured to couple or control the branch (or auxiliary connection—e.g. 270b). The contactor 610 controls the current through the branch, disconnecting or reconnecting the branch per se or the charging station powered by the branch. The load shedder may, for example, comprise a magnetic contactor controllable via control signals transmitted by the controller 310. Thus, the controller 310 can be adapted to control, via load shedding or reconnection control signals, the load shedder 610, for example between a charging configuration/status and offloaded/load shed configuration/status. The charging configuration corresponds to the branch being connected and the charging station recharging the battery, and where the load shedded or disconnected configuration corresponds to the branch being offloaded. In the event that a load controller 600 is used rather than an interception box 602, intermediate configurations are also possible, where the current flow is controlled or modulated on the branch. The controller 310 is configured to generate control signals to control the load shedder 610 depending on the availability of residual power, as will be described in more detail below. In the example shown in FIG. 3, the load controller 602 may further comprise a circuit breaker 612 and one or more terminal blocks 271 for coupling the units' main feeder 260 and a branch 270 (or auxiliary load line). The load controller 602 may include transducers 514, 516 to provide data or signals indicative of current (or power) consumption on the unit's main feeder 260 and/or branch 270 (load line).

In some embodiments, the system 300 does not include interception boxes 602, as third-party charging station controllers are already installed or available. In this case, these external charging station controllers 600 may already be installed in the building 100, to control the charging of electric vehicles associated with dwellings, and may be equipped with their own load-shedding devices. The system 300 then comprises the controller 310 and the I/O module 320 which can be connected to the external charging station controller 600. Control signals can be transmitted by the system 300 to the external charging station controller 600, enabling a branch to be active/connected or offloaded/disconnected via the external charging station controller 600. For example, the system 300 can be installed in an existing building equipped with one or more charging station controllers (from RVE™, ChargePoint™, EVBox™, or other load monitoring and load shedding devices). Control signals generated by the 300 system can be transmitted from wires or cable connections to be connected to the dry contacts of the charging station regulators/controllers. Control or command signals may also be conditioned to directly control a relay or circuit breaker associated with a branch. For example, when a branch is connected directly to a unit's electrical panel, a control wire carrying load-shedding or reconnection control signals can be connected to a main panel circuit breaker to control the offloading of the branch by opening of closing the branch circuit.

The protocol used by system 300 to transmit control signals can be a standardized protocol, such as the Open Charge Point Protocol (OCPP). Other protocols may also be considered, such as IEC 63110 or ISO15118. Preferably, connections are wired, but wireless signal transmission may also be considered.

With reference to FIGS. 2 and 3, the 300 system may also include auxiliary control means configured to control auxiliary systems or common services/loads. For example, when the parking lots of an apartment building are located in the basements of the building, a ventilation system 120 is usually installed to prevent the accumulation of toxic emissions or to maintain a desired temperature, fed for example by the secondary connection or line 240d having a transducer 512d, and whose consumption in kWh is measured by the meter 250e. In some embodiments, the controller 310 is configured and capable of generating load shedding and reconnection control signals for common service devices, based on configured activation periods. For example, the 310 controller can control the activation or deactivation of electrical devices, such as the 120 ventilation system, according to the consumption measured on the branches, or according to a given number of electric vehicles being charged at a given time. In these embodiments, the 330 interface module can display the status of devices used for common loads, such as the ventilation system, or any other relevant data related to common load consumption.

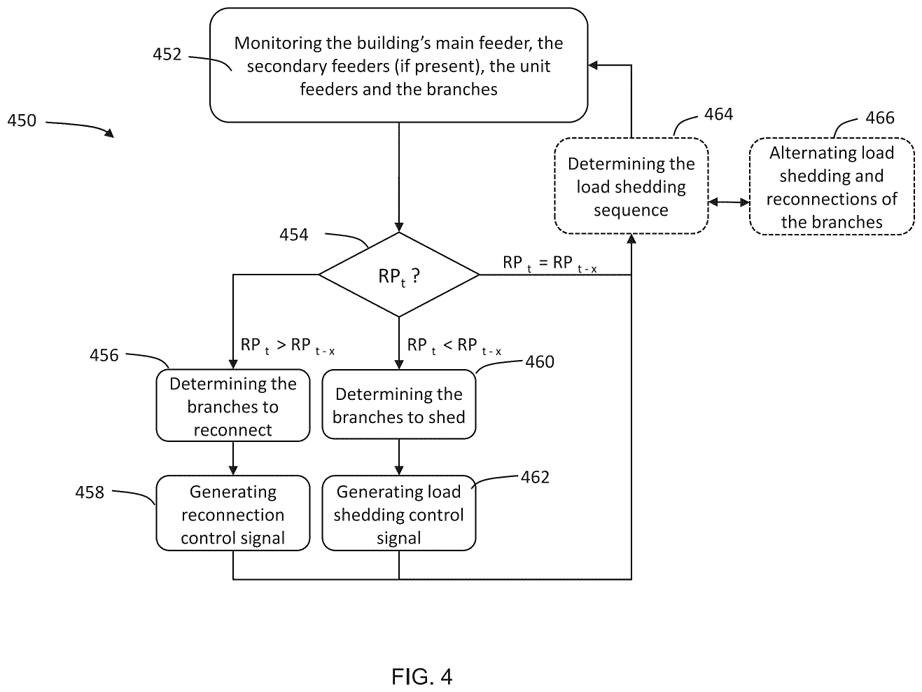

Referring to FIG. 4, a possible implementation of a method 450 for protecting a building's electrical infrastructure is shown. Method 450 may include, among other steps, monitoring current or power on the building's main feeder, secondary feeder(s), unit main feeders and/or branches. Current, power consumption or branch status can be monitored, for example, via signals transmitted by charging stations, contactor interception boxes and/or charge controllers. The method can also include the management or control of electrical infrastructure loads, for example via the generation of load-shedding and/or branch reconnection control signals, thus providing a dynamic load-shedding system, which protects the entire electrical infrastructure of a building, including the building's main feeder and secondary feeders, where present according to the configuration of the electrical infrastructure.

In one possible embodiment, method 450 can be performed by the system 300 described above. Method 450 can be used to manage the residual power, or residual load available, on the main supply line of a multi-family building, or on its branch lines, by controlling the recharging of electric vehicle batteries via charging stations connected to the building's electrical infrastructure. Method 450 can be carried out continuously or periodically, depending on the needs and/or size of the building or installation.

Method 450 includes, in step 452, monitoring the current or power consumed by loads supplied by the main building feeder, secondary feeders associated with power transformers or main unit feeders. As mentioned above, this step can be carried out by the controller, via measurements transmitted or read from transducers located on the various feeders. Some of the measurements, such as those associated with the branches, may come from load controllers external to the 300 system. This monitoring may be carried out in real time or periodically. Monitoring of the main building feeder may include measuring power, for example by measuring current and voltage, and determining total energy consumption by all loads connected to the main building feeder. In step 454, the method can include determining a residual power (PRt) on the main building feeder on the secondary feeder(s) or on the main feeders of the units. For example, this determination can be made by calculating the difference between the maximum power (or maximum current) allowed on these different lines, and the total consumption measured. The maximum authorized power can be determined according to current or power thresholds configured using the 330 interface module, these thresholds being set according to the configuration and specific components of the 200 electrical infrastructure. Two types of thresholds can be configured for each type of line, a maximum consumption threshold (also known as a load-shedding or protection threshold) and a safety or minimum threshold, enabling a buffer zone to be created, preventing the alternating connection and disconnection of one or more auxiliary lines, thus avoiding generating instability on the infrastructure's supply lines.

If the residual power at a given time (PRt) exceeds the residual power at a previous time (PRt−x), the method may comprise, in step 456, generating a reconnection control signal to reconnect at least one of the leads. The method may include determining which of the branches is/are to be reconnected or de-energized. When the total energy consumption, i.e. including on the main building feeder and on secondary feeders, drops below the safety thresholds associated with these feeders, i.e. below a level low enough to allow reconnection of a feeder, and therefore recharging of an electric vehicle, the controller can generate one or more reconnection control signals to reconnect the off-loaded feeders. Furthermore, in step 456, the controller can be configured to compare the PRt (or current equivalent) with additional thresholds or parameters, entered via interface module 22, to determine which branch(es) can be reconnected. Time constraints can be added so that when power consumption allows a branch to be reconnected, a reconnection or reconnection delay or duration is applied before a new reconnection control signal is issued, to avoid repeatedly disconnecting and reconnecting branches. In some embodiments, the controller's decision to reconnect a branch may be based on measured power or current levels, so that a new branch is reconnected only when residual power reaches levels within set safety thresholds. If the controller determines that an additional branch can be connected, the method can include reconnecting this branch in step 458. This reconnection can be achieved by sending a reconnection control signal. This signal can be transmitted to a charge controller or interception box associated with this branch, or to a load-shedding device associated with the charging station connected to the branch. Other connection/disconnection modes can also be envisaged.

If the residual power at a given point in time (RPt) is lower than the residual power at a previous point in time (RPt−x), e.g. when the energy consumption of the units increases, the system can determine, in step 460, whether one or more branches need to be unloaded (or disconnected) to keep the total energy consumption below or up to the maximum permitted power, again depending on the set thresholds associated with at least the main building feeder and/or secondary transformer feeders. As in step 456, further constraints, thresholds and parameters can be checked before a branch is unloaded, or decoupled, from the associated main unit feeder. Once it has been determined that a branch is to be de-loaded, the method may include, in step 462, sending a de-load control signal to disconnect the branch(es). As described above, the control signal may be intended for a load controller(s) or correspond to a load-shedding device control signal for disconnecting or decoupling the branch from the main unit feeder.

In one possible embodiment, if the residual power at the given instant remains relatively unchanged between the given instant and an earlier instant, for example when the total building load is stable, as determined in step 454, no particular branch connection or load shedding action is performed.

In step 464, method 450 can further include determining the sequence of branch load shedding or reconnection, to ensure a fair and safe distribution of electric vehicle battery recharging time, based on the respective energy consumption of the loads associated with the branches. This step can be performed after steps 454, 458 or 462, but can also be performed before steps 458 or 462. Step 464 can also be carried out continuously or periodically, independently of total energy consumption monitoring. In the protection system 300, each branch can be associated with a counter (timer) for tracking the connection time from the moment a branch is connected, i.e. and a charging station is active. The operation of the counter can be determined or configured via the interface module 330 and taken into account by the controller 310 of the system 300. The status or consumption of each branch is monitored/measured by a load monitoring device (such as a transducer) to track the energy consumption of an electric vehicle powered via the branch. In one possible embodiment, the controller 310 can control the load shedding and reconnection sequences of the branches according to the values of the counter associated with each branch and according to the current (or power) consumption on the branch. When all charging stations are connected, the controller monitors the energy consumption (current or power) and connection time of each charging station. However, when the residual power is less than the power required to keep all the branches connected, the controller can be configured, as in step 466, to generate load-shedding signals for either the branches or the charging stations that have reached one or more of the energy consumption and connection time thresholds, and to replace them by connecting other branches (or charging stations) with lower connection time and/or energy consumption values. In other words, according to one possible embodiment, the controller can be configured to perform steps 464 and 466, to distribute the supply of electrical energy between charging stations as a function of the connection times of the charging stations and as a function of the consumption by each of the stations.

For example, with reference to FIG. 1, only two (270b, 270c) of the three branches (270b, 270c, 270d) can be kept connected to their respective unit feeders when residual power allows only two charging stations to be connected at a time. However, to prevent the third charging station from remaining inactive for a prolonged period, thus preventing the charging of an electric vehicle, the controller can monitor the three branches with time counters associated with each branch, counting the charging time for each associated station. The controller is capable of disconnecting/loadshedding one of the two connected branches and reconnecting the third branch, by generating load-shedding or reconnection control signals. The duration and power consumption thresholds can be set in the same way for all branches. However, in some embodiments, the method allows specific parameters to be set for each branch, using the interface module 330. The signals transmitted by the controller 310 may be intended for contactors, to completely de-energize the branches, or may be intended for charging station controllers or for charging stations, when they are manufactured to be able to receive instructions via a standardized protocol. The contactors may be located in a charging station controller (600) or in an interception box (602), depending on the equipment in place when the protection system 300 is installed in a building.

In one embodiment, a dwelling owner may subscribe to a service that reduces the charging time for his or her vehicle, in which case the building manager may increase the duration and/or energy consumption thresholds associated with the unit owner's branch. In addition, the controller 310 can take into account the energy consumption of the unit or charging station when distributing residual energy over the branches. As a result, a unit owner with consistently high energy consumption on his branch can be assigned lower time and/or energy consumption thresholds for recharging his vehicle. Conversely, a connection terminal with a longer connection time may not be disconnected if no electric car has been charged during the connection time.

In some embodiments, step 464 can use counters to determine which branch has been connected the longest, so that load shedding is performed sequentially in a given order. For example, first-in, first-out (FIFO) or last-in, first-out (LIFO) principles can be used to determine which branches to connect/disconnect. Other strategies for managing branch disconnection and reconnection can be envisaged without departing from the present system.

The method can also include steps to disconnect each branch independently of the residual power available, for example in case of an emergency.

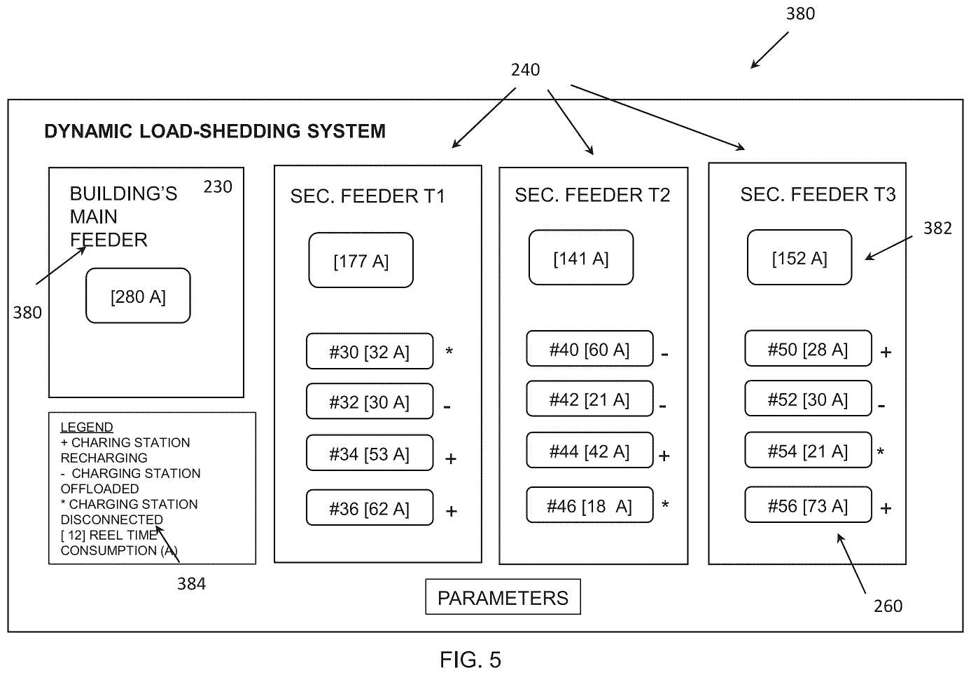

With reference to FIGS. 5 to 10, the building electrical infrastructure protection system 300 can protect the various components of the building's electrical infrastructure (or network), including protection devices. In some embodiments, the system controller 310 can monitor, via current transducers, the amperage (current) of infrastructure feeders, such as the building's main feeder (building's primary line), the amperage (current) of secondary feeders (or secondary connections) connected to transformers (depending on the network configuration) and the amperage of unit feeders. According to the embodiment, the system controller 310 also monitors either the state of the branches or the amperage (or power consumed) on the branches. By “branch status”, we mean, for example, whether the branches are active or “on charge”, i.e. with an electric vehicle being charged; whether they have been shed or off-loaded; or whether they are inactive, i.e. the charging station associated with the branch being disconnected. Depending on the measurements and/or status of the various infrastructure feeders and branches, the system controller can cut off power to the branches (by controlling NC/NO contactors in a charging station controller or a contactor in an interception box, for example), and therefore to the associated charging stations, when the energy demand becomes too great, for example during peak consumption periods. These protection thresholds can be applied to the building's main feeder, to secondary feeders (depending on the infrastructure configuration) and to the units' main feeders. In another embodiment, depending on the model of the charging station and the protocol for controlling it (e.g. OCPP), the controller 310 can send a control signal to modulate the load consumed by the charging station (in % or according to a given profile). In this way, the load available to the charging station can be dynamically controlled. Load shedding can therefore be performed dynamically.

In one possible embodiment, protection of the electrical infrastructure can help prevent consumption overload at three different levels, either at the unit level, at the level of secondary feeders connected to transformers, or at the level of the building's main feeder (building's main supply line).

### Overload on a Main Feeder of a Unit

In the case of an overload limited to a single unit, when current consumption exceeds a load-shedding (or protection) threshold associated with the units, the power supply to the branch, and therefore to the associated charging station, can be shed/offloaded or modulated until power demand falls below a safety threshold associated with the units, for a certain period of time, called the demand stabilization time.

### Overload on a Secondary Feeder Connected to a Transformer

In the case of an overload on a secondary feeder, which supplies a group of several units, the system can be configured to cut power to one or more branch (or associated charging station(s) for a given time, called the load-shedding duration, and can repeat this action for each overload episode. Several charging stations can therefore be shed or off-loaded, one after the other, depending on the demand for electricity.

If, as a result of one or more load shedding operations, current demand is below the load shedding threshold associated with the secondary feeder, but above the safety threshold for the secondary feeder, the system can be configured to alternate charging station disconnections between the available charging stations. This means that, for example, if two out of three charging stations are shed/offloaded, the system can allow one out of three charging stations to be charged alternately, depending on the duration of the loadshedding.

When demand falls below the safety threshold associated with the secondary feeder(s) for a certain period of time, corresponding to the demand stabilization time, the system can be configured to reconnect the branches (or charging stations) one at a time, while spacing out the reconnections to avoid further overloads, according to a time delay between reconnections. If reconnecting a charging point increases demand beyond the safety threshold associated with the secondary feeder, the system will resume alternating load shedding of the remaining branches/charging points until demand falls back below the safety threshold of the secondary feeder, before performing further reconnections.

### Overload on the Building's Main Feeder

In the event of an overload on the building's main feeder, i.e. all secondary feeders (if present) and the units' main feeders, the system can be configured to impose a load-shedding action on all associated branches and/or charging stations. This load shedding can be achieved either by controlling contactors present in interception boxes or third-party charging station controllers, or via a communication protocol (e.g. OCPP), by sending a control signal directly to the charging stations. The system can then reconnect the branches or charging stations according to a predetermined sequence. In one possible embodiment, in the event of a power outage affecting the entire building, the system can be configured to impose complete load shedding of the branches and to reconnect according to a predetermined sequence. Here, by load shedding or disconnection of the recharging terminals, and reconnection of the recharging terminals, these operations may correspond to the generation of control or command signals, by the controller 310, to switches and contactors associated with the charging stations and/or the branches, or to charging station controllers associated with some of the building's units.

With reference to FIG. 5, the interface module 330 may consist of a panel or window 380 for displaying the consumption 382 of the building's various connections, notably including the building's main feeder and/or each secondary feeder. A representation of the main feeder 230, of the secondary feeders associated with the transformers 240 and of the main feeders of the various units 260 is displayed, in real time or at a predetermined refresh rate. These displays can show the current consumption (in amperes, or alternatively, of the power) in real time for each type of connections. The display panel can also show in real time a status 384 of the branches (and therefore of the charging stations), indicating for example, by a color code or pictogram, whether a charging station is charging, in load shedding or not connected. Note that the amperages shown in FIG. 5 are given by way of example only and represent only a “snapshot” or “capture” of what an operator consulting the display panel might see, and that these data are constantly changing as they are displayed in real time (or refreshed according to a given refresh period). The values indicative of the electrical consumption (e.g. current or power consumption) of each feeder and the connection status of the charging stations associated with the branches are transmitted by the various transducers installed on the feeders of the electrical infrastructure to the control unit 306, via communications that are preferably, but not necessarily, wired. Some of the values displayed may also be transmitted to the control unit 306 via third-party charge controllers, or via “intelligent” charging stations, i.e. charging stations that can communicate via a standardized protocol (e.g. OCPP).

With reference to FIG. 6, a unit identification panel (or window) 396 is shown, forming part of the interface module 330. Through this panel, it is possible to identify units, for example, by their civic numbers in the case of dwellings, in order to facilitate subsequent configuration and control steps. In this example, the dwellings are numbered from 1 to 8, but it is understood that the controller's display and commands can be adapted according to the configuration of the building's electrical infrastructure, i.e. system 300 can be adapted according to the number of units. For other types of building, such as a marina, the units could correspond to electric boat berths on a marina dock.

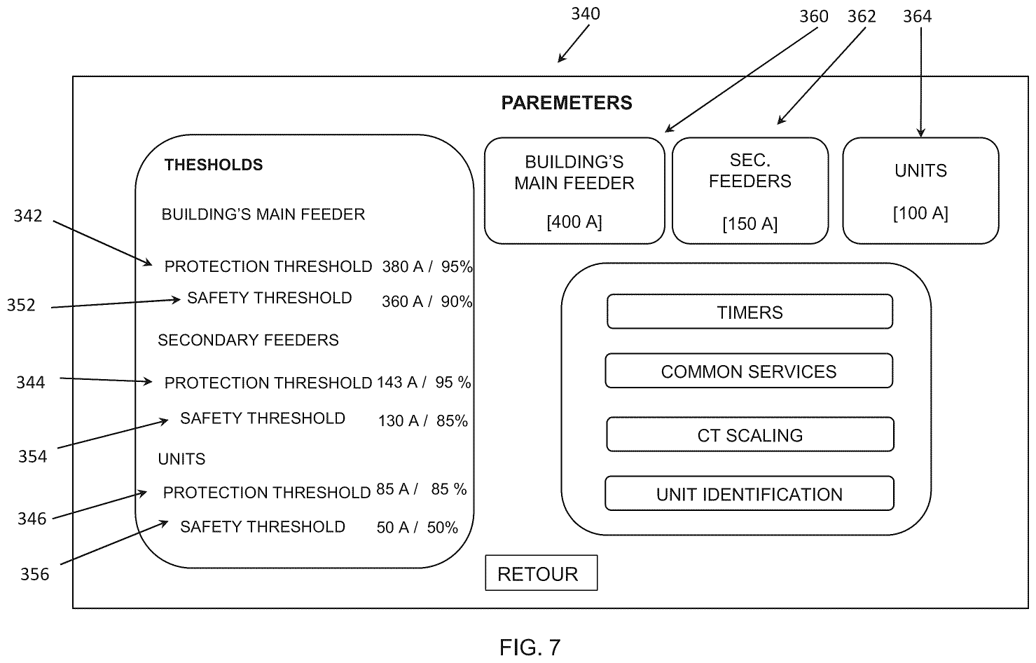

With reference to FIG. 7, an example of a panel (or window) for configuring the protection thresholds 340 of the electrical feeders of the infrastructure is shown, forming part of the interface module 330. Through this panel, the capacity or amperage of the building's main feeder 360, the capacity of the secondary feeders 362 and the capacity of the main feeders of the units 364 may be entered. In this example, all unit main feeders have the same capacity, but it is possible to set a capacity per unit main feeder, for example if electrical panel capacities differ from unit to unit. For each type of feeder or connection, the panel can be used to set a load-shedding threshold (or protection threshold) and a safety threshold. The interface module is therefore able to set a first load-shedding threshold associated with the main feeder 342, a second load-shedding threshold associated with the secondary feeders 344 and a third load-shedding threshold associated with the unit feeders 346. Here again, a single threshold is set for the three secondary feeders, and a single threshold is set for the unit feeders, but it may be possible to set separate thresholds per secondary feeder and/or per unit feeder. A load-shedding threshold represents a limit, for example in amperes, above which the controller 310 of the system 300 generates a load-shedding control signal to cut off power to one or more electric vehicle charging stations.

The interface module can also be used to set a first safety threshold associated with the main building feeder 352, a second safety threshold associated with the secondary feeders 354 and a third safety threshold associated with the main unit feeders 356. A safety threshold represents a limit, in this case in amperes, below which the controller 310 of the system 300 generates a control signal to reconnect power to one or more branches or electric vehicle charging stations. A percentage can also be displayed, calculated from the protection values of the building's main feeder, secondary feeders and specified unit feeders.

Still referring to FIG. 7, according to one possible embodiment, in the protection thresholds configuration panel (page or window), the system operator can indicate the desired protection threshold values. These thresholds can be defined as follows:
Load-shedding threshold (amp.): The load-shedding threshold can represent the limit, in amperes, above which the system causes the supply to electric vehicle charging stations to be cut off.
Safety threshold (amp.): The safety threshold represents the limit, in amperes, below which the system reconnects power to electric vehicle charging stations.
(%): The percentage displayed is calculated from the protection values of the main feeder, secondary feeders and unit feeders of previously specified units.

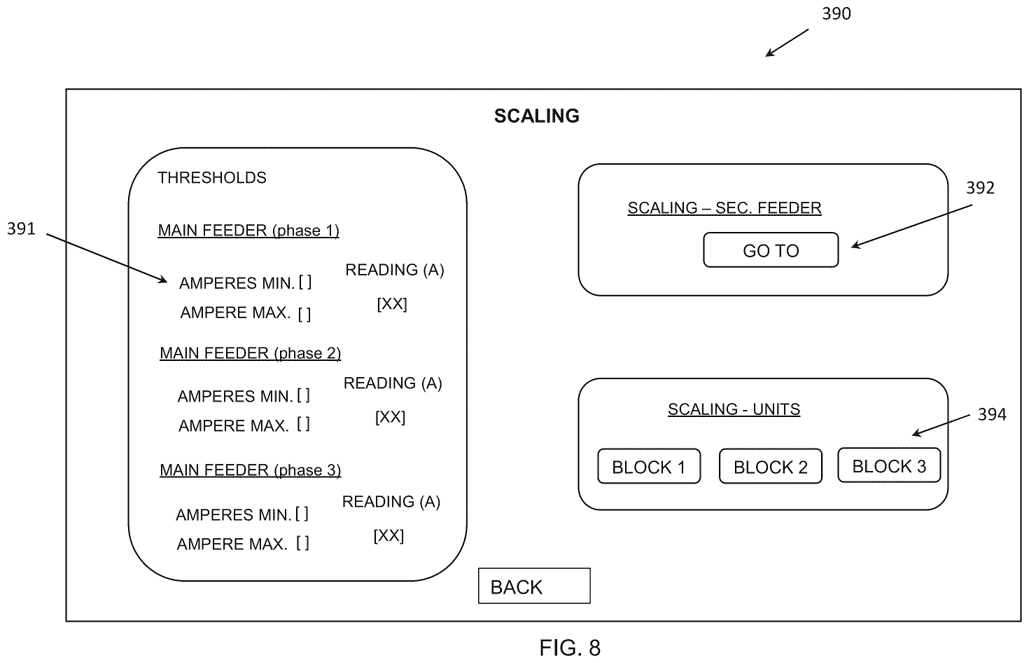

With reference to FIG. 8, the interface module may include a scaling panel (or window) 390, which may also be called a calibration panel, for calibrating measurements from the transducers. This panel is optional and may not be present, for example, if the transducer model used does not require calibration. This calibration step is optional. In one possible embodiment, prior to calibration, this panel 390 can be used to indicate the minimum and maximum current values according to the capacity of the main building feeder 391 and/or the secondary feeders 392 and/or the unit feeders of a block 394. Using a clamp-on ammeter and a potentiometer transducer to be calibrated, with the transducer installed on a conductor of a feeder (building main, transformer-related secondary or unit main), the potentiometer can be adjusted to read the same value as that displayed on the scaling panel, visible in the “reading (amp.)” section, as on the clamp-on ammeter. If the potentiometer adjustment does not prove sufficiently accurate, it is possible to fine-tune by slightly modifying the minimum and maximum values entered via the scaling panel. Note that current transducer calibration can be considered complete when the 390 panel interface displays the same value as that shown on the current clamp. It is preferable to calibrate transducers when actual consumption is not too low. For example, it is not recommended to calibrate a transducer on a secondary feeder if real time consumption is below 50% of its capacity. When a transducer with selector is used, it is possible to select the current amplitude by moving the selector to the desired value. Unlike transducers with a potentiometer, the position of your selector can be indicated in the “Max. amps” box of the given line conductor, either the main feeder of the building, the secondary feeder or the main feeder of individual dwellings. In one possible embodiment, depending on the transducers (CT) used, a check of the data transmitted by the transducers can be carried out, to ensure that there is an adequate load to protect the electrical installation.

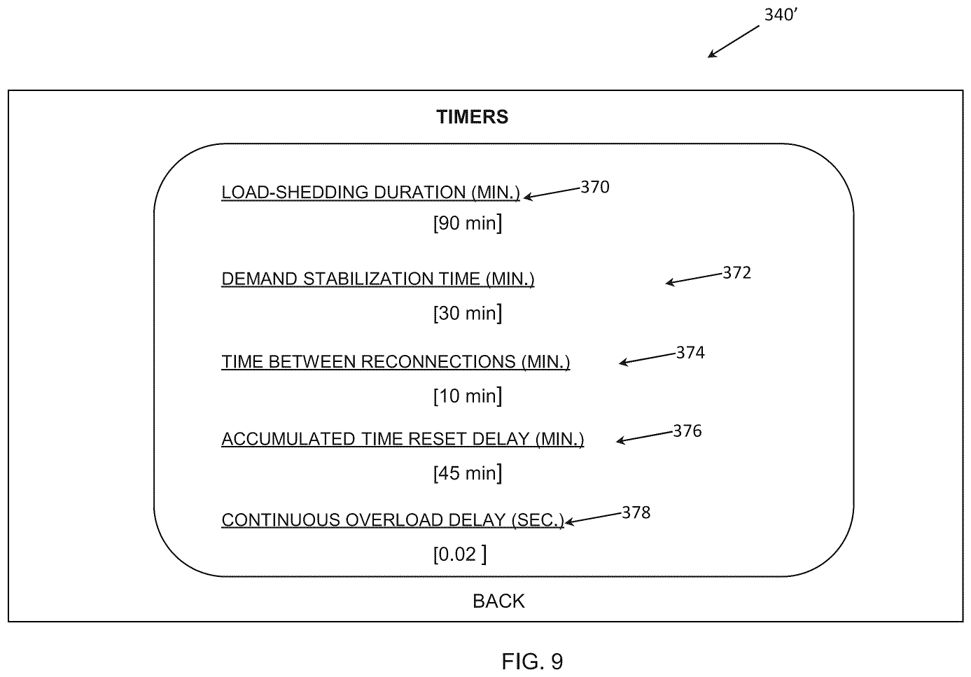

With reference to FIG. 9, the interface module may also include a 340′ configuration panel (page or window), enabling the controller's 310 operations to be set while considering load shedding and reconnection times and delays. The interface module can be used to set a branch load-shedding time 370 before the controller 310 can generate reconnection control signals. In this way, the load-shedding time can correspond to the time (or period), for example in minutes, during which the power supply to a charging station is interrupted during a load-shedding operation. For example, if one out of two charging stations is unloaded and the “unloading duration” parameter is 90 minutes, the two charging stations will be unloaded alternately for a period of 90 minutes.

Still referring to FIG. 9, the interface module can be used to set a stabilization time 372 during which the power consumed on one of the: main building feeder; secondary feeders; and main unit feeders must remain below their respective safety thresholds before the controller sends reconnection control signals. Thus, the stabilization time may correspond to the time (or period) in minutes that the demand must remain below the safety threshold before the reconnection sequence begins. For example, if the charging station associated with a dwelling is unloaded following an overload on the dwelling's feeder, when the dwelling's consumption falls below the safety threshold (third safety threshold), the consumption (in current) must remain below this threshold for the demand stabilization time before the system 300 reconnects the station (i.e. generates a reconnection signal). This stabilization time 372 prevents successive reconnections and load shedding.

Still referring to FIG. 9, the interface module can be used to set a reconnection delay before the controller 310 can generate a reconnection control signal following the sending of a load-shedding signal. In this way, the reconnection delay can correspond to the time, for example in minutes, between reconnections of the load-shed terminals. For example, when the 310 controller sends signals to reconnect the load-shedding terminals, the reconnection delay imposes on the controller a delay between reconnections in order to stabilize the effect of this reconnection on the electrical demand for the infrastructure, to avoid creating an overload.

Still referring to FIG. 9, the interface module can be used to set a charging time reset delay associated with the charging station branches, the charging time being saved by the controller to prioritize some of the branches. The accumulated time reset delay may correspond to the time, for example in minutes, before the 310 controller resets the charging counter (timer) once a vehicle has been disconnected by its owner. For example, the 310 controller monitors the charging time of each electric vehicle (by a signal received from a charge controller or from the interception box associated with a branch, via transducers) and prioritizes the charging of vehicles that have a lower charging time than others. When a vehicle's charging station is disconnected by the owner, the system resets its charging time so that it starts from zero the next time that it is charged. This reset delay ensures fairness between the charging times assigned to different vehicles by the controller, in the charging sequence of the various connected charging stations. So, when the time between disconnection and reconnection of a charging station by a user exceeds a certain time, the branch or charging station is moved to the end of the queue in the charging sequence of the stations managed by the controller. This feature prevents a user who purposely connects and disconnects his or her charging point from ending up at the front of the charging sequence, while other charging points/branches are waiting in the charging queue.

Still referring to FIG. 9, the interface module can be used to set an overload delay after which an overload on one of the building's main feeder, secondary feeders, and main unit feeders will be taken into account by the controller. A continuous overload delay may correspond to the time (or period), for example in seconds, required for an overload to be perceived by the 310 controller. Note that if the input value is too small, the 310 controller may be too sensitive to current fluctuations. If it is too large, the system may not react quickly enough in the event of an overload. It is understood that the delays and durations shown in FIG. 9 are only possible data and that these values are determined by the configuration of the building's electrical infrastructure (e.g. number of dwellings, number of charging stations, etc.).

In summary, still with reference to FIG. 9, according to one possible embodiment, in the 340′ timer configuration panel (page or window), the system operator can indicate the values of the desired durations or delays, associated with load shedding. These delays or durations can be defined as follows:
1. Load-shedding duration: Time in minutes during which the power supply to a charging station is interrupted during a load-shedding operation. Example: If one of two bollards is unloaded and the unloading duration parameter is 90 minutes, the 2 bollards will be unloaded alternately for 90 minutes.
2. Demand stabilization time: time in minutes during which demand must fall below the safety threshold before the reconnection sequence begins. Example: A dwelling's terminal becomes unloaded following an overload. When the consumption of this dwelling falls below the safety threshold, it must remain below this threshold for the duration of demand stabilization before the system reconnects the terminal. This avoids successive reconnections and load shedding.
3. Time between reconnections: Time in minutes between reconnections of load-shedding terminals. Example: When the system starts reconnecting load-shedding terminals, it imposes a delay between reconnections in order to assess the effect of its action on electrical demand, and avoid creating an overload itself.
4. Accumulated time reset delay: Time in minutes before the system resets the charge counter once the vehicle has been disconnected by the owner. Example: The system monitors the charging time of each electric vehicle and prioritizes the charging of those with a lower charging time than the others. When a vehicle's charging station is disconnected by the owner, the system resets its charging time so that it starts from zero the next time it is charged.
5. Continuous overload delay: Time in seconds required for an overload to be detected by the system. Note: If the input value is too small, the system may be too sensitive to current fluctuations. If it is too large, the system may not react quickly enough in the event of an overload.

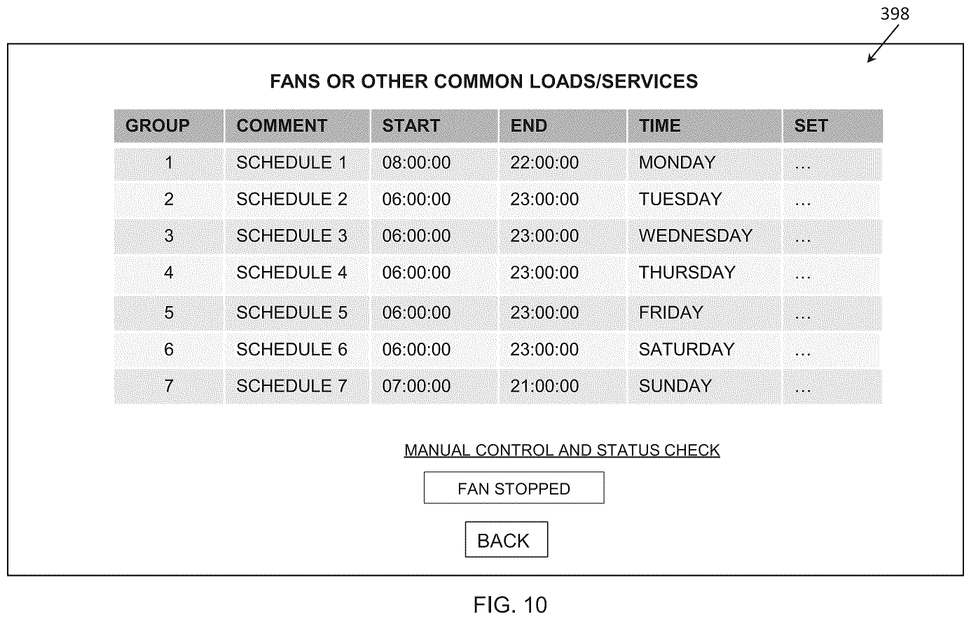

With reference to FIG. 10, for a building comprising a number of secondary feeders, one of which is dedicated to supplying common services (as shown in FIG. 2), the interface module can be used to configure activation periods for devices supplied by the common services secondary feeder or connection. The interface module can therefore include a common services configuration panel 398, an example of which is shown in FIG. 10. The controller can then generate load shedding and reconnection control signals for devices/common loads connected to the branch line (such as fans, lighting, auxiliary heating) according to the configured activation periods.

Here with reference to FIGS. 5 to 10, although the display panels (or windows) are shown grouping certain parameters or functionalities, it is understood that these panels may be grouped or separated differently, and that the displays shown are only one possible mode of realization. The interface module may comprise more or fewer panels, presenting different information or by being grouped differently, without departing from the scope of the present invention. Furthermore, although consumption is indicated in current/amperes on the display panels, other equivalent parameters can be used, such as power (in kW or kWh), percentages or ratios, without departing from the scope of the present invention.

As explained above, the aim of a building's electrical infrastructure protection system is to protect the building's electrical protection devices by managing the load shedding of branches or charging stations. Via its control unit, the system uses current transducers to monitor the amperage of the main feeder, secondary feeders (branches of the main feeder) and feeders to individual dwellings, and cuts the supply to charging stations if demand becomes too great during peak consumption periods.

In the event of an overload, the system can handle three scenarios:

Overload at unit level: In the case of an overload limited to a single unit, i.e. if consumption exceeds the load-shedding threshold, the power supply to the charging station will be cut off until electricity demand falls below the safety threshold for a certain period of time (called the demand stabilization time).

Branch overload: In the event of an overload on a complete branch (i.e. a group of several dwellings), the system will cut the power supply to a charging point for a given time (load shedding time) and repeat this action for each overload episode (several charging points can therefore be load shed one after the other, depending on the demand for electricity).

If, following one or more load shedding operations, demand is below the load shedding threshold but above the safety threshold, the system will alternate between the available charging points. This means that, for example, if 2 out of 3 charging stations are shed, the system will alternate between one out of three charging stations, depending on the duration of the shedding.

When demand falls below the safety threshold for a certain period of time (demand stabilization time), the system will then reconnect the charging stations one at a time, spacing out reconnections to avoid further overloading (delay between reconnections). If reconnecting a charging point increases demand beyond the safety threshold, the system will resume alternating load shedding of the remaining charging points until demand falls back below the safety threshold, before reconnecting again.

Overload at main input: In the event of an overload at the main input (i.e. all branches and homes), the system imposes a load shedding action on all charging stations. The system will then reconnect the charging stations according to the method presented in point 2 (overload on a branch). In the event of a power cut, the system will also impose a complete load shedding and reconnect the charging stations according to the same method.

The system and method described herein are particularly suitable for installation in multi-unit buildings, such as multi-unit residential buildings comprising between 4 and 96 units. The building may comprise a metering center connected to and fed by the building's main feeder line, and including electrical meters associated with each unit. Each main unit feeder, with or without a branch line, can therefore be connected to a respective electricity meter to monitor the consumption of each unit. The system can then monitor the building's main feeder, the secondary feeders associated with the transformers, the main feeders of the units, and manage energy consumption by connecting or disconnecting branches to recharge batteries for electric vehicles or other types of loads.

In addition, with the proposed protection system, it is possible to protect a sector of a power supplier's electrical network by controlling the connection of branches for several buildings. For example, during periods of high power consumption in a given sector of the supplier's electrical network, the current system can remotely relieve (completely or in part, for example as a percentage of the available load) the branches of several buildings so as to relieve the overconsumption of power in one sector of the network. The current system can also be used to remotely modify the protection thresholds, for one or more buildings, of the main, secondary or residential feeders, for example by lowering the amperage limits, in order to have a greater residual load to redistribute.

It should also be understood that, while this document is particularly suited to the monitoring and management of a main line of multi-unit buildings, the system can be adapted for installation in other environments or facilities without departing from the document. For example, the system could be installed in marinas or marinas with charging stations for electric boats, in office towers offering charging stations to tenants, in commercial buildings or any type of building.

The inventive concept has been described in terms of specific embodiments, executions and configurations, which are only intended to serve as examples. Persons of ordinary skill in the art will appreciate, after reading this description, that many variations, modifications and refinements can be made without departing from the inventive concept(s) presented herein.

1. A system for load management and protection of electrical infrastructure in a building with a plurality of units, the electrical infrastructure comprising a protection device protecting a main feeder of the building, the main feeder of the building being served by a mains line provided by a power distributor; secondary feeders derived from the main feeder of the building and connected to transformers associated with a metering center; unit feeders connected to the metering center; and branches associated with some of the main feeders of units for powering added loads, the protection system comprising:
an input/output (I/O) module for
receiving signals indicating current or power consumption on the building's main feeder; current or power consumption on the secondary feeders; current or power consumption on the unit feeders, and connection statuses of the branches;
transmit load-shedding or reconnection control signals to load-shed or reconnect at least one of the branches or added loads associated therewith;
an interface module for setting a first load-shedding threshold associated with the main feeder, a second load-shedding threshold associated with the secondary feeders and a third load-shedding threshold associated with the main unit feeders; and
a controller connected to the input/output module and the interface module, configured to generate the control signals when the current or power consumed on at least one of: the building's main feeder, the secondary feeders, and the unit feeders exceeds one of the first, second or third load-shedding thresholds.

2. The protection system of claim 1, wherein the first, second and third load-shedding thresholds represent the limits, in amperes, above which load-shedding control signals are generated to cut off power to the branches or the added loads.

3. The protection system according to claim 2, wherein:
the interface module is able to set a first safety threshold associated with the building's main feeder, a second safety threshold associated with the secondary feeders and a third safety threshold associated with the unit feeders,
the first, second and third safety thresholds representing the limits, in amperes, below which reconnection control signals are generated to reconnect the shed branches.

4. The protection system according to claim 3, wherein the interface module comprises an interface to set a duration for branch load shedding before the controller can generate reconnection control signals.

5. The protection system according to claim 3, wherein the interface module comprises an interface to set a stabilization time during which the power consumed on one of: the building's main feeder; the secondary feeders; and the unit feeders must remain below their respective safety thresholds before the controller sends reconnection control signals.

6. The protection system according to claim 4, wherein the interface of the interface module allows setting a reconnection delay before the controller can generate a reconnection control signal following the transmission of a load-shedding signal.

7. The protection system according to claim 3, wherein the interface module comprises an interface to set a charging time reset delay associated with the branches, the charging time being saved by the controller to prioritize some of the branches.

8. The protection system according to claim 1, wherein the interface module comprises an interface to set an overload delay after which an overload on one of: the building's main feeder; the secondary feeders; and the unit feeders will be taken into account by the controller.

9. The protection system according to claim 1, designed for when the building has several secondary feeders, one of which is dedicated to the supply of common services, the interface module allowing to configure activation periods for devices supplied by said secondary feeder dedicated to common services, the controller generating the load-shedding and reconnection control signals intended for the devices as a function of the configured activation periods.

10. The protection system according to claim 1, wherein the interface module comprises a display panel showing in real time the current or power consumed on the building's main feeder; the secondary feeders and/or the unit feeders.

11. The protection system according to claim 10, wherein the display panel shows the connection status of each branch in real time.

12. The protection system of claim 11, wherein the connection status is indicative of charging, load shedding or non-connection of charging stations associated with the branches.

13. The protection system according to claim 1, in which the signals indicative of the current or power consumed on the feeders or indicative of the connection status of the branches come from transducers installed on the building's main feeder; the secondary feeders, and the unit feeders.

14. The protection system according to claim 13, wherein the transducers associated with the main building feeder are located in the building protection device, the transducers associated with the secondary feeders are located in transformers and the transducers of the main unit feeders are located in charging station controllers or interception boxes.

15. The protection system according to claim 1, further comprising electric vehicle charging station controllers or unit feeder interception boxes, each charging station controller or unit feeder interception box being connected to one of the branches and to the electrical panel of the unit associated with a charging station supplied by the branch.

16. The protection system according to claim 1, wherein the signals indicative of the current or power consumed on each unit feeder come from electric vehicle charging station controllers which are external to the protection system.

17. The protection system according to claim 1, wherein control signals and/or signals indicative of current, power or connection status are transmitted to the controller by wired communications.

18. The protection system according to claim 17, wherein the communications are carried out according to one of the following protocols: Open Charge Point Protocol (OCPP), IEC 63110 or ISO15118.

19. The protection system according to claim 14, wherein the controller is configured to transmit load shedding control signals to the charging station controllers, to the interception boxes associated with the respective unit feeders or to the charging stations directly, when the power consumed on the building's main feeder or on one of the secondary feeders exceeds their associated load shedding thresholds.

20. The protection system according to claim 14, wherein the control signals enable load shedding or connection of one or more of the branches by activating a circuit opening mechanism in one of the charging station controllers or in one of the unit feeder interception boxes.

21. The protection system according to claim 1, further comprising an application interface for accessing the controller to obtain the current or power values of the building's main or secondary feeders and/or the connection status of the branches.

22. A protection system for protecting the electrical infrastructure of a building comprising a plurality of units, the electrical infrastructure comprising a protection box protecting a main feeder of the building, a metering center, unit feeders connected to the metering center and branches associated with some of the unit feeders for powering charging stations, the protection system comprising:
an input/output (I/O) module for
receiving signals indicative of: current or power consumption on the building's main feeder; current or power consumption on the unit feeders; and branch connection status;
transmitting control signals enabling load-shedding or reconnection of at least one of the branches or charging stations;
an interface module for setting a first load-shedding threshold associated with the building's main feeder and a second load-shedding threshold associated with the unit feeders; and
a controller connected to the input/output module and the interface module, configured to generate the control signals when the current or power consumed on the building's main feeder or on one of the unit feeders exceeds one of the load-shedding thresholds.

23. The protection system of claim 22, wherein the first and second load-shedding thresholds represent the limits, in amperes, above which the control signals are generated to load-shed or modulate the branches or the charging stations.

24. The protection system according to claim 23, wherein:
the interface module is able to set a first safety threshold associated with the building's main feeder and a second safety threshold associated with the unit feeders,
the first and second safety thresholds representing the limits, in amperes, below which reconnection control signals are generated to reconnect the shed branches.
